(19) United States
(12) Patent Application Publication
(10) Pub. No.: US 2007/0144131 A1
(43) Pub. Date: Jun. 28, 2007

(54) Adjustable side mower

(76) Inventor: Tracy V. McKee, Pheba, MS (US)

Correspondence Address: SETO PATENTS, 406 RIVERLAND DR., SALEM, VA, 24153, US

(21) Appl. No.: 11/318,947

(22) Filed: Dec. 27, 2005

(51) Int. Cl. A01D 34/64

(52) U.S. Cl. 56/14.9

(57) ABSTRACT

A lawn mowing device that is adapted to be attached to the back of a tractor. The device includes a boom that extends a mowing deck to the side of the tractor so a surface can be mowed without the tractor having to actually drive on top of the surface. The mowing deck can also be angled up or down so that sloping surfaces can be uniformly cut. The present side mower allows for easy mowing of river and pond banks, which are often soggy and hard to traverse with a vehicle or traditional lawnmower. The side mower is attached to the back of a tractor via a standard three-point hitch. A counterweight is provided in the back of the side mower to offset the weight of the extended mowing deck and prevent the tractor from tipping over. The mowing deck preferably includes it's own 5-hp motor that provides power to the blades that are housed under of the mowing deck.

### BACKGROUND OF THE INVENTION

The present invention relates generally to the field of grass and brush mowers and more specifically to a side mower that allows mowing of areas not easily reached by conventional mowers.

Conventional lawn mowers are well-known and used by landscapers and homeowners on a daily basis. A traditional lawn mower includes a blade that is suspended inches above the ground and rotated at high speeds by a small internal combustion engine. The blade and engine are supported by and separated by a chassis with the blade below the chassis and the engine above the chassis. The traditional lawn mower has four wheels that allow the lawn mower to be easily rolled over a flat lawn. A handle extends from the chassis to height of three or four feet so that a person can move the lawn mower forwards and backwards by pushing or pulling on the handle, respectively.

Towed lawn mowers are mowers that are attached to the back of a tractor or other vehicle. These towed lawn mowers do not require their own engines and receive the power required for rotating their blades from the tractor's engine. An auxiliary drive train from the tractor is connected to the towed mower's drive shaft to provide a rotational force for the blade. The mower is then towed behind the tractor and grass or brush can be cut wherever the tractor can drive. The problem with these traditional towed mowers is that mowing is limited to generally flat areas and other stable areas where the tractor can drive. Traditional towed mowers cannot mow severely declining areas such as the banks of a river or pond, nor can they cut severely inclining areas such as the sides of a mountain road.

What is needed in the field is an adjustable towed mower that allows the blades of the mower to reach to the side of the tractor so that the tractor can travel along side of the area to be mowed. The ideal side mower would also have a mowing deck that could be angled so that inclining and declining areas, relative to the path of the tractor, can be efficiently mowed.

### SUMMARY OF THE INVENTION

An adjustable side mower that allows easy mowing of pond banks, ditches and hedge rows. The side mower is adapted to be attached to the back of a towing vehicle, such as a tractor, and extends to one side of the tractor for mowing a surface on that side of the tractor. The side mower allows for mowing of wet areas without the tractor having to actually drive on the wet areas. The side mower comprises a mower base, wherein the base includes a frame with multiple tractor attachment points that are adapted to be attached to the tractor and a counterweight that is supported by the frame on a back side of the frame. The mower also includes an extendable and retractable boom. The boom has first and second legs, wherein the first leg of the boom is pivotally attached to a lower portion of the front side of the base frame. The second leg of the boom is pivotally attached to a mowing deck, which includes at least one lawnmower blade, a blade housing that covers a top and four sides of the blade(s), and a mowing deck support that is attached to the top of the blade housing. A 5-hp engine is preferably attached to the mowing deck, wherein the engine provides the rotational force for turning the blades of the mowing deck.

The first leg of the boom is connected to and actuated by a first adjustable device that is also connected to the front of the frame. The first adjustable device, which can be a hydraulic piston or a hand-winch, is able to maneuver the first leg of the boom closer to and further away from the frame, respectively. A second adjustable device is connected to the top of the boom and a top portion of the mowing deck support. The second adjustable device, which is also a hydraulic piston or hand-winch, is able to maneuver the mowing deck support closer to and further away from the second leg of the boom, respectively. The boom and adjustable devices allow the mowing deck to be raised above the level of the tractor and lowered below the level of the tractor. The boom and adjustable devices also allow the mowing deck to be angled up or down relative to the tractor.

A set of controls for controlling the engine and lawnmower blades, and optionally controlling the boom, is co-located on the side mower or remotely located, on the tractor, for example. The tractor attachment points on the base frame preferably comprise a standard three-point hitch for tractors. When the first and second adjustable devices are hydraulic pistons, the pistons can be adapted to receive hydraulic power from the tractor. Alternatively, the side mower engine can include a hydraulic pump that selectively provides power to the hydraulic pistons.

It is an object of the present invention to provide a mower that allows the cutting of grass and brush on surfaces that are not easily traversed by vehicles or traditional mowers.

### BRIEF DESCRIPTION OF THE DRAWINGS

The invention of the present application will now be described in more detail with reference to the accompanying drawings, given only by way of example, in which:

FIG. 1 is a perspective view of the preferred embodiment;

FIG. 2 is a side cross-section view of the mowing deck;

FIG. 3 is a side cross-section view of the counter weight of the preferred embodiment; and,

FIG. 4 shows a side view of the preferred embodiment.

### DETAILED DESCRIPTION OF THE INVENTION

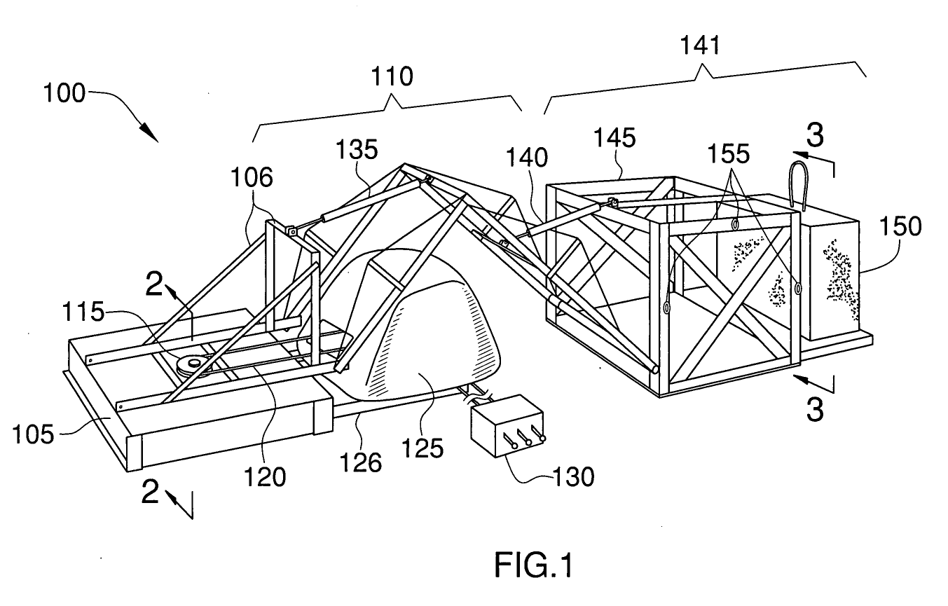

FIG. 1 shows a perspective view of the present adjustable side mower 100. The present mower 100 is adapted to be carried behind a tractor or other towing vehicle (not shown). The side mower's base 141 can be supported behind the tractor and three-point hitches 155 are provided on two sides of the frame 145, in the preferred embodiment, to facilitate mowing on both the left and right hand sides of the tractor. The base 141 includes a counterweight 150 that offsets the weight of the extendable portion of the present mower 100. The mower blades that do the actual cutting of grass and brush are contained underneath of the mowing deck 105. The blades receive their rotational force from a 5 horsepower (hp) internal combustion engine, in the preferred embodiment, a well-known engine in the field. The engine is connected to the blades via drive belt 120 and pulley 115. The engine housing 125 is connected to the mowing deck by support structure 126. The mowing deck 105 and engine are connected to the side mower's base 141 by boom 110. Boom 110 is roughly in the shape of an “A”, without the short middle portion. One leg of the boom 110 is pivotally attached to the mowing deck 105, via a mowing deck support 106, and the other leg of boom 110 is pivotally attached to the mower base 141. Hydraulic piston 140 causes the boom 110 to rotate relative to the attachment point on the base 141. This allows the side mower 100 to mow hillsides and riverbanks, i.e., surfaces that are higher and lower than of the tractor. Second hydraulic piston 135 causes the mower deck 105 to rotate relative to the boom's attachment point on the mowing deck 105. This degree of freedom allows the mowing deck to be angled so that the mowing deck can conform to any sloping of the surface to be mowed. The controls 130 for the boom 110 and the engine can be on the side mower 110, so they can be operated from the base, or the controls 130 can be remotely located from the side mower, so that they can also be operated from the attached tractor.

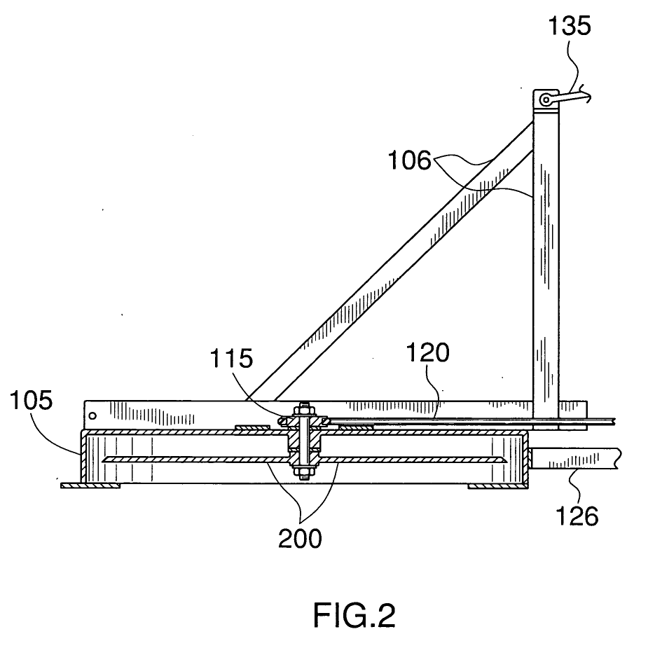

FIG. 2 shows a side cross-sectional view of the mowing deck 105. The blades 200 of the mowing deck are completed enclosed on five sides, with only the bottom side being partially open, in the preferred embodiment. The 5-hp engine held by support structure 126 is used to rotate the drive belt 120. Drive belt 120 turns pulley 115, which in turn rotates the blades 200. A portion of hydraulic piston 135 can be seen attached to the top of mowing deck support 106. This attachment point of piston 135 allows the mowing deck 105 to be angled up and down to facilitate mowing of inclining and declining surfaces, respectively.

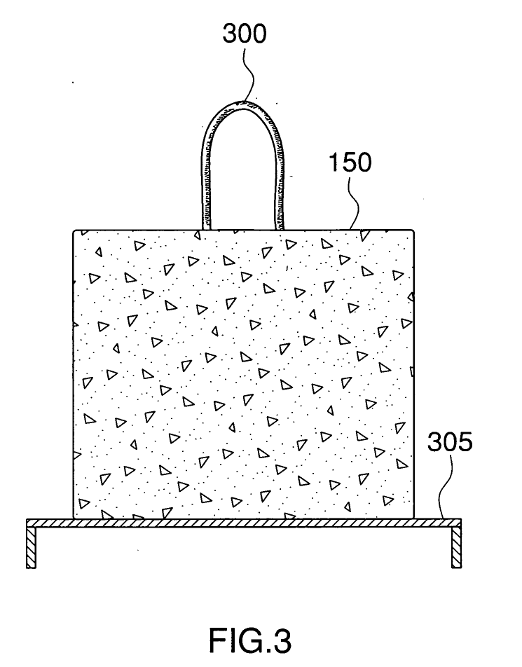

FIG. 3 shows a cross section of the counterweight 150, which is made of concrete in the preferred embodiment. Of course, other counterweights including metal can be used with the present invention. The counterweight 150 is provided with a handle 300 or other means for assisting in placing and removing the counterweight onto and off of the rear portion 305 of the side mower's base. The counterweight 150 is used to offset the weight of the mowing deck and engine so that the towing vehicle does not feel any torque from the present side mower that would otherwise induce the towing vehicle to tip over.

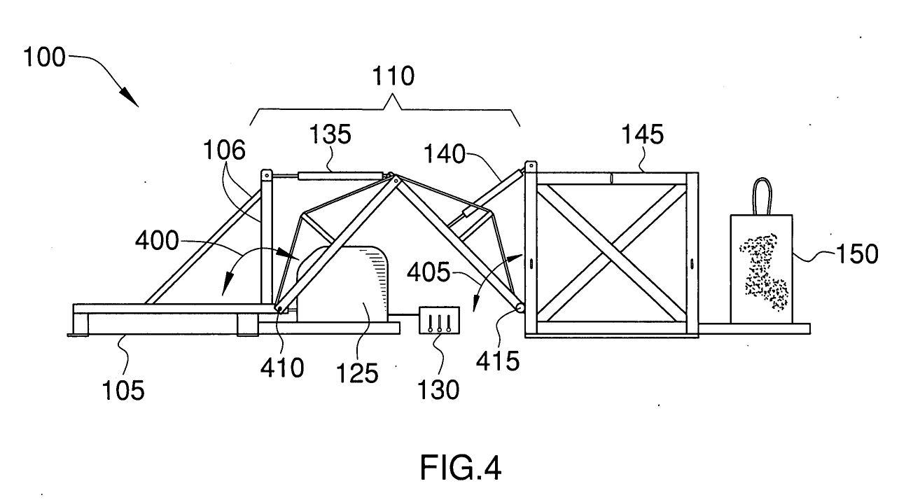

FIG. 4 shows a side view of the preferred embodiment of the present adjustable side mower 100. The left leg of boom 110 attaches to the lower portion of mowing deck support 106 at pivot point 410. This pivot point 410 allows the mowing deck 105 to be angled up and down, as shown by arrow 400, when piston 135 is retracted and extended, respectively. The right leg of boom 110 attaches to the lower portion of base frame 145 at pivot point 415. This pivot point 415 allows the entire mowing deck 105 to be raised and lowered, relative to the level of the base frame 145, when piston 140 is retracted and extended, respectively. Arrow 405 shows the direction of movement around pivot point 415. Each pivot point is preferably a hinge with cotter pin so that each pivot point can also become a detachment site by simply removing the cotter pin. Engine housing 125, controls 130 and counterweight 150 can also be seen in this view. In an alternative embodiment, the two pistons 135 and 140 are replaced by hand-winches.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. An adjustable side mower that allows easy mowing of pond banks, ditches and hedge rows, the side mower is adapted to be attached to a towing vehicle, including a tractor, and adjustably extends out from one side of the tractor thereby allowing for mowing of angled and soggy surfaces without the tractor having to actually drive on the angled and soggy surfaces, the side mower comprising:
a mower base, wherein the base includes a frame with multiple tractor attachment points that are adapted to be attached to the tractor, and a counterweight that is supported by the frame on a first side of the frame;
an extendable and retractable boom, the boom having first and second legs, wherein the first leg of the boom is pivotally attached to a lower portion of a second side of the frame, the second side of the frame being opposite of the first side of the frame;
a mowing deck, wherein the mowing deck includes at least one lawnmower blade, a blade housing that covers a top and four sides of the blade(s), a mowing deck support that is attached to a top of the blade housing, wherein a lower portion of the mowing deck support is pivotally attached to the second leg of the boom;
an engine that is attached to the mowing deck, wherein the engine provides a rotational force for turning the at least one lawnmower blade;
a first adjustable device that is connected to the second side of the frame and the first leg of the boom, the first adjustable device being able to pull and push the first leg of the boom closer to and further away from the frame, respectively;
a second adjustable device that is connected to a top of the boom and a top portion of the mowing deck support, the second adjustable device able to pull and push the top portion of the mowing deck support closer to and further away from the second leg of the boom, respectively; and,
a set of controls for controlling the engine and the lawnmower blade(s).

2. The adjustable side mower of claim 1, wherein the multiple tractor attachment points on the base comprise a standard tractor three-point hitch.

3. The adjustable side mower of claim 1, wherein the first and second adjustable devices are hydraulic pistons and each piston is adapted to receive hydraulic power from the tractor, and wherein the set of controls also control movement of the hydraulic pistons.

4. The adjustable side mower of claim 1, wherein the side mower further includes a hydraulic pump that is attached to the engine, and the first and second adjustable devices are hydraulic pistons that receive hydraulic power from the hydraulic pump, and wherein the set of controls also control movement of the hydraulic pistons.

5. The adjustable side mower of claim 1, wherein the set of controls is located on the side mower.

6. The adjustable side mower of claim 1, wherein the set of controls is located on the tractor.

7. The adjustable side mower of claim 1, wherein the boom can be detached from the frame.

8. The adjustable side mower of claim 1, wherein the mowing deck can be detached from the boom.

9. The side mower of claim 1, further comprising an engine cover that substantially covers the engine.

10. The side mower of claim 1, wherein the counterweight is made of a heavy material, including concrete and metal, and the counterweight weighs at least as much as the mowing deck and engine.

11. The side mower of claim 1, wherein the counterweight includes a lift assisting device, including a handle, that aids in placing and removing the counterweight.

12. The side mower of claim 1, wherein the frame has the general shape of a box, the boom has the general shape of an “A”, and the mowing deck support is in the general shape of a triangle.
